(19) United States
(12) Patent Application Publication
(10) Pub. No.: US 2019/0360245 A1
(43) Pub. Date: Nov. 28, 2019

(54) Floor Securing Door Brace

(71) Applicant: Ty Warden, Oklahoma City, OK (US)

(72) Inventor: Ty Warden, Oklahoma City, OK (US)

(21) Appl. No.: 16/252,847

(22) Filed: Jan. 21, 2019

Related U.S. Application Data
(60) Provisional application No. 62/675,448, filed on May 23, 2018.

(51) Int. Cl. E05C 19/00

(52) U.S. Cl. CPC E05C 19/003; E05Y 2900/132

(57) ABSTRACT

A floor securing door brace designed to prevent intruders from forcibly entering a room. The floor securing door brace includes an elongated member having a first end and a second end. The first end includes an inverted U-shaped member that is designed to removably engage with a doorknob of a door. The U-shaped member has an apex and an opening disposed opposite the apex. The second end is designed to removably engage with a tubing disposed in the floor, thereby securing the elongated member against the door. The tubing is dimensioned and configured such that the elongated member is maintained in a vertical upright position and secured against the door regardless of how the doorknob is oriented. In this way, a user is able to easily and quickly enable additional security when preventing intruders from entering a room.

### CROSS REFERENCE TO RELATED APPLICATIONS

This application claims the benefit of U.S. Provisional Application No. 62/675,448 filed on May 23, 2018. The above identified patent application is herein incorporated by reference in its entirety to provide continuity of disclosure.

### BACKGROUND OF THE INVENTION

The present invention relates to door braces. More specifically, the present invention provides a door brace assembly including a tubing in a floor aligned with a door handle and an elongated member having a first end adapted to secure overtop a doorknob and a second end adapted to fit flush within the tubing.

Unfortunately, it has become increasingly common for individuals to suffer from malicious break-ins. These attacks may occur in homes, schools, or other public areas. An individual can potentially protect themselves from intruders by locking a door. However, if the door requires a key to lock, then the individual may not be able to find the key to lock the door in the time required. Although it is also possible for the individual to barricade the door, it can be difficult for the individual to have the presence of mind to effectively barricade the door against an intruder. Thus, an improved floor securing door brace that can efficiently prevent an intruder from forcibly entering a building or room is desired.

### SUMMARY OF THE INVENTION

In view of the foregoing disadvantages inherent in the known types of door security now present in the known art, the present invention provides a floor securing door brace wherein the same can be utilized for providing convenience for the hen desiring to enable additional security when preventing intruders from entering a room.

The present system comprises a floor securing door brace. The floor securing door brace comprises an elongated member having a first end and a second end. The first end comprises an inverted U-shaped member that is configured to removably engage with a doorknob of a door, wherein the U-shaped member includes an apex and an opening disposed opposite the apex. The second end is configured to removably engage with a tubing disposed in the floor, thereby securing the elongated member against the door. The tubing is configured to support the elongated member in an upright vertical position, and is dimensioned such that the elongated member does not require support from the doorknob and remains upright and secured regardless of how the doorknob is oriented. In this way, a user is able to easily and quickly enable additional security when preventing intruders from entering a room.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the floor securing door brace.

FIG. 2A shows a perspective view of an embodiment of the floor securing detailing the tubing disposed in the floor.

FIG. 2B shows a perspective view of an embodiment of the floor securing door brace detailing a bracket aligned with the tubing disposed in the floor.

FIG. 3 shows a perspective view of an embodiment of the floor securing door brace in use.

### DETAILED DESCRIPTION OF THE INVENTION

Reference is made herein to the attached drawings. Like reference numerals are used throughout the drawings to depict like or similar elements of the floor securing door brace. The figures are intended for representative purposes only and should not be considered to be limiting in any respect.

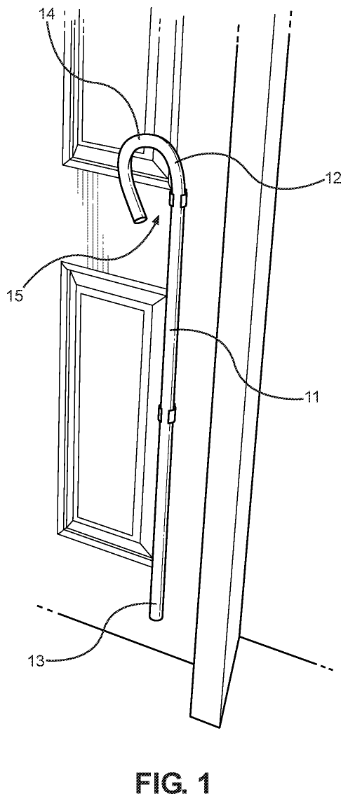

Referring now to FIG. 1, there is shown a perspective view of an embodiment of the floor securing door brace. The floor securing door brace includes an elongated member 11 having a first end 12 disposed opposite a second end 13. The first end 12 comprises an inverted U-shaped member having an apex 14 and an opening 15, such that the first end 12 is configured to removably engage with a doorknob. The first end 12 is oriented such that the apex 14 and opening 15 are aligned with one another in a common plane. Additionally, the opening 15 is dimensioned to receive the doorknob therein; as such, the opening 15 is oriented such that the opening 15 is aligned with the second end 13 and configured to have the apex 14 rest flush overtop the doorknob. In this way, the floor securing door brace is configured to sit supported on the doorknob when in use. Additionally, embodiments of the present invention can be effectively used with any style or shape of door handle or doorknob.

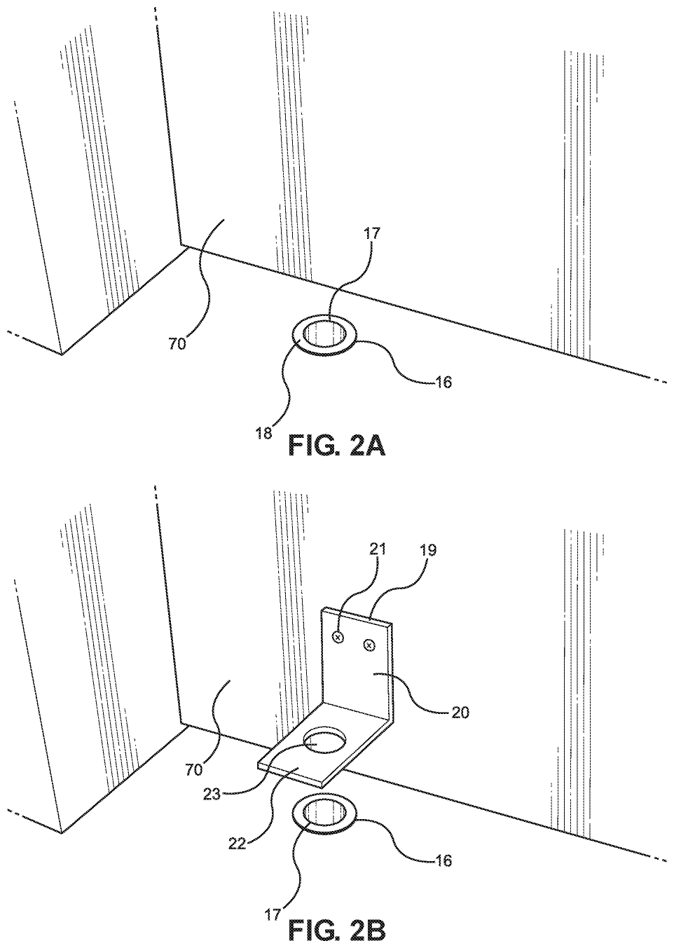

Referring now to FIG. 2A, there is shown a perspective view of an embodiment of the floor securing detailing the tubing disposed in the floor. The floor securing door brace further comprises a tubing 16 disposed in the floor. The tubing 16 includes an aperture 17 configured to accept the second end of the elongated member therein. Thus, the tubing 16 is positioned proximate to the door 70, wherein the aperture 17 is positioned to align with the doorknob. In this way, when the first end of the elongated member is disposed atop the doorknob, the second end of the elongated member naturally aligns with the aperture 17 of the tubing 16, allowing the user to quickly secure the door 70 in a closed position.

In the illustrated embodiment, the tubing 16 is dimensioned such that the second end of the elongated member rests flush therein, such that the elongated member is supported in an upright vertical orientation. Additionally, in the shown embodiment the tubing 16 further comprises a reinforced lining 18, such that elongated member cannot be forced out of the tubing 16 should excessive pressure be applied to the elongated member through the door 70. In the shown embodiment, the outer edge of the lining 18 extends outwardly from the perimeter of the tubing 16 and partially covers a portion of the floor surrounding the tubing 16, such that the outer edge of the lining 18 prevents the elongated member from damaging the area of the floor surrounding the tubing 16.

Referring now to FIG. 2B, there is shown a perspective view of an embodiment of the floor securing door brace detailing a bracket aligned with the tubing disposed in the floor. In one embodiment, the floor securing door brace further comprises a bracket 19 that is configured to aid the user in securing the elongated member against the door 70. The bracket 19 thereby allows a user to secure the door 70 when the door 70 opens outwardly as opposed to inwardly.

In the illustrated embodiment, the bracket 19 comprises a first side 20 disposed flush against the door 70, wherein the first side 20 is secured to the door via one or more fasteners 21. In the illustrated embodiment, the bracket 19 is secured to the door 70 via screw fasteners 21. However, any other suitable fasteners 21 may be utilized. The bracket 19 additionally comprises a second side 22 extending from a lower edge of the first side 20. wherein the second side 22 is oriented perpendicular to the first side 20 such that the second side 22 extends outwardly away from the door 70 and is aligned with the floor. The second side 22 of the bracket 19 includes a bracket aperture 23 configured to accept the second end of the elongated member therethrough. Thus, the bracket 19 is positioned on the door 70 such that the bracket aperture 23 is aligned with the aperture 17 of the tubing 16 when the door 70 is in the closed position. In the illustrated embodiment, the bracket 19 is positioned on the door 70 proximate to the floor. However, in other embodiments, the bracket 19 is positioned on the door 70 proximate to the doorknob or elsewhere along the door 70, so long as the bracket aperture 23 is aligned with the aperture 17 of the tubing 16.

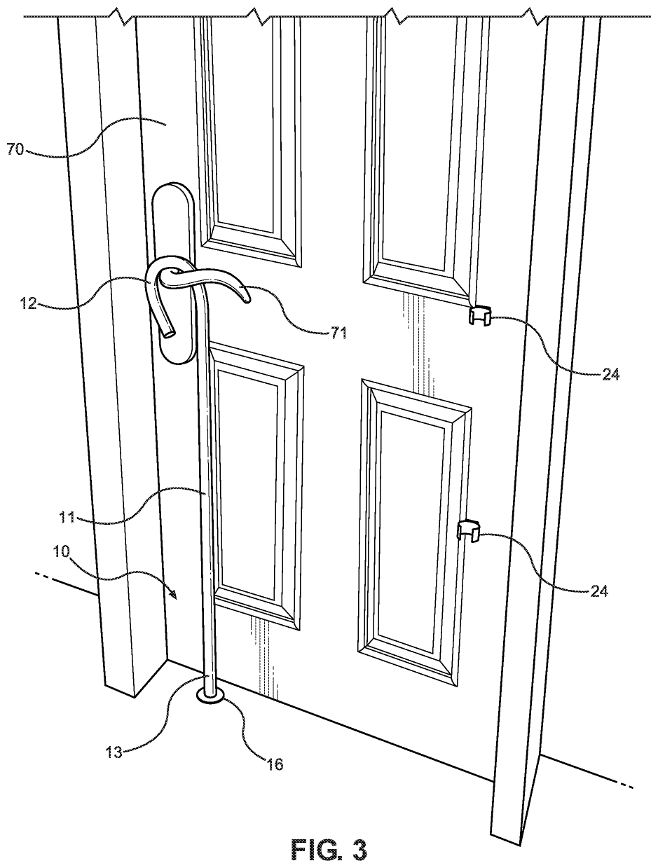

Referring now to FIG. 3, there is shown a perspective view of an embodiment of the floor securing door brace in use. The elongated member 11 is dimensioned such that the first end 12 can rest overtop a doorknob 71 while the second end 13 is simultaneously disposed within the tubing 16. In the illustrated embodiment, the elongated member 11 is dimensioned such that the second end 13 can rest within the tubing 16 and support the elongated member 11 such that the elongated member 11 remains upright even if the doorknob 71 is not supporting the first end 12.

The floor securing door brace 10 further comprises a pair of storage clips 24 disposed on the door 70 opposite the doorknob 71. The storage clips 24 are configured to accept and retain the elongated member 11 therein, such that the user can easily store the elongated member 11 against the door when not in use. In the illustrated embodiment, each storage clip 24 includes a pair of arcuate arms biased towards one another, such that the elongated member 11 is frictionally secured therebetween.

In operation, a user removes the elongated member 11 from the storage clips 24 and closes the door 70. The user then inserts the second end 13 of the elongated member 11 into the tubing 16 disposed within the floor and rotates the elongated member 11 such that the first end 12 is disposed atop the doorknob 71, thereby preventing an individual from opening the door 70. In this way, a user can efficiently secure a door to prevent an unwanted individual from entering.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A floor securing door brace, comprising:
an elongated member having a first end and a second end;
wherein the first end comprises an inverted U-shaped member that is configured to removably engage with a doorknob of a door;
wherein the second end is configured to removably engage with a tubing disposed in the floor thereby securing the elongated member against the door;
wherein the tubing is configured to support the elongated in a vertical upright position.

2) The floor securing door brace of claim 1, further comprising a bracket affixed to the door, wherein the bracket includes a bracket aperture configured to align with the tubing when the door is in a closed position.

3) The floor securing door brace of claim 2, wherein the bracket comprises a first side mounted flush to the door via one or more fasteners, and a second side affixed to a lower edge of the first side and extending outwardly from the door, wherein the second side is oriented perpendicular to the first side.

4) The floor securing door brace of claim 1, further comprising one or more storage clips disposed on the door configured to receive the elongated member therein.

5) The floor securing door brace of claim 4, wherein the one or more storage clips comprises a pair of arcuate arms biased towards one another.

6) The floor securing door brace of claim 1, wherein the tubing further comprises a reinforced lining therein.

7) The floor securing door brace of claim 6, wherein the reinforced lining includes a perimeter portion that extends outwardly from the tubing to cover a portion of a floor.
